(19) United States
(12) Patent Application Publication
(10) Pub. No.: US 2009/0047512 A1
(43) Pub. Date: Feb. 19, 2009

(54) Dispersed metal nanoparticles in polymer films

(76) Inventor: Jeffrey L. Conroy, Allen, TX (US)

Correspondence Address: K&L Gates LLP, STATE STREET FINANCIAL CENTER, One Lincoln Street, BOSTON, MA, 02111-2950, US

(21) Appl. No.: 11/921,829

(22) PCT Filed: Jun. 6, 2006
(86) PCT No.: PCT/US2006/022104

§ 371 Date: Dec. 6, 2007

Related U.S. Application Data
(60) Provisional application No. 60/687,787, filed on Jun. 6, 2005.

(51) Int. Cl. B32B 5/02; B29C 39/00

(52) U.S. Cl. 428/338; 264/319; 264/311; 977/777

(57) ABSTRACT

A method of forming a thin film of metal nanoparticles useful in optics and electronics includes producing a mono-layer of dispersed metal nanoparticles substantially free of stabilizing ligands. Mixing a polymer solution with a metal salt to create a metal precursor solution. Forming the metal precursor solution into a film by removal of solvent, and heating the film to reduce the metal salt and form metal nanoparticles. Further heating the film to remove the polymer solution and form a monolayer of dispersed metal nanoparticles.

### FIELD OF THE INVENTION

The invention relates to the field of thin films useful for optics and electronics.

### BACKGROUND

The preparation of thin films of metal nanoparticles is of interest for a number of applications in optics and electronics. Typical preparation of metal nanoparticles consists of the reduction of a metal salt precursor solution in the presence of a stabilizing reagent. For gold nanoparticles, this is typically accomplished by using an aqueous solution of citric acid and gold chloride, in which the citric acid acts as both reducing agent and stabilizing reagent for the formed gold nanoparticles. Other reducing agents and solvents are known, and the formation of a variety of metal nanoparticles have been reported using a variation of this reaction type to form stable colloids that exhibit the optical properties of individual non-interacting metal nanoparticles.

Using a stable colloid to prepare cast films leads to aggregation during the evaporation of the solvent. As the aggregation of the particles occurs, the optical properties become that of the aggregate, losing the desired function of individual nanoparticles. Similarly, well dispersed metal nanoparticles have been grown in solid or semisolid films such as glasses, polymers, and ceramics such as metal oxide films, by the dispersion of the precursor salt in the matrix, followed by subsequent reduction by a chemical reducing agent or ionizing radiation, such as ultraviolet light or gamma radiation.

Such films can also be formed by the mixing of pre-formed nanoparticles and the matrix material in a suitable solvent, followed by casting of the mixture and subsequent drying. These methods, however, result in a stable film of nanoparticles with either stabilizing ligands or particle suspended in a stable matrix. For many applications, a method that results in the generation of a monolayer of aggregate free “naked” nanoparticles which exhibit the optical properties of the well dispersed colloid is desirable.

### SUMMARY OF THE INVENTION

The invention relates to a method of producing a monolayer of dispersed metal nanoparticles substantially free of stabilizing ligands, and the film produced thereby. The method includes the step of mixing a polymer solution with a metal salt to Create a metal precursor solution. The metal precursor solution is formed into a film by removal of solvent. The solvent may be removed by heating the metal precursor solution. Heat is applied to the film to reduce the metal salt and form metal nanoparticles. The film is further heated to remove the polymer solution and form a monolayer of dispersed metal nanoparticles.

In an embodiment, the method of forming the metal precursor solution into a film includes spin casting the metal precursor solution. The metal salt may include a metal from the group of gold, silver, copper, and platinum. In an embodiment, the metal salt may be gold (III) chloride trihydrate. The polymer solution may be selected from the group of water soluble polymers of polyvinyl alcohol, polymethylvinyl ether, polyarrylates, polyacrylamides, polysaccarides, gelatins, polylactic acid, and polyglycolic acid. In an embodiment, the polymer solution is aqueous polymethylvinyl ether. The dispersed metal nanoparticles in the monolayer may be between about 2 nm and about 100 nm.

### BRIEF DESCRIPTION OF THE DRAWINGS

FIG. 1 is a photomicrograph of a metal film with dispersed metal nanoparticles.

FIG. 2 is a histogram of particle sizes of an embodiment of the present invention.

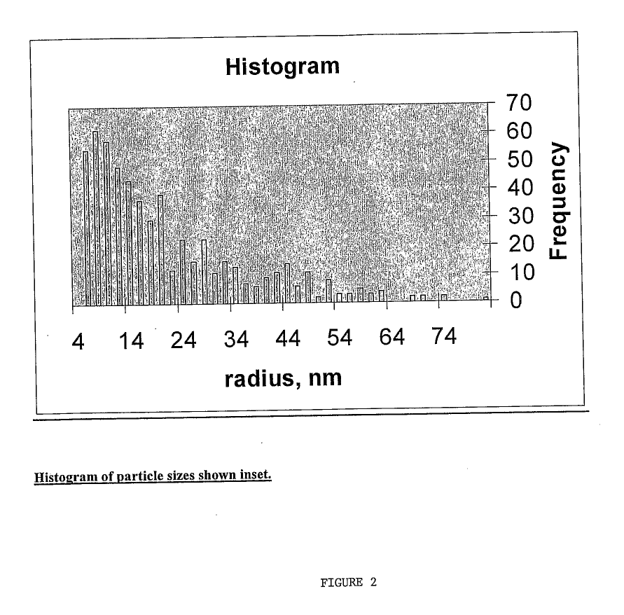

### DETAILED DESCRIPTION OF THE INVENTION

The disclosure herein provides for a general method for the preparation of monolayers of dispersed metal nanoparticles free from stabilizing ligands, which retain the optical properties of the dispersed colloid. A method of producing a monolayer of dispersed metal nanoparticles substantially free of stabilizing ligands, and the film produced thereby are herein provided. The method includes the step of mixing a polymer solution with a metal salt to Create a metal precursor solution. The metal precursor solution is formed into a film by removal of solvent. The solvent may be removed by heating the metal precursor solution. Heat is applied to the film to reduce the metal salt and form metal nanoparticles. The film is further heated to remove the polymer solution and form a monolayer of dispersed metal nanoparticles.

In an embodiment, the method of forming the metal precursor solution into a film includes spin casting the metal precursor solution. The metal salt may include a metal from the group of gold, silver, copper, and platinum. In an embodiment, the metal salt may be gold (III) chloride trihydrate. The polymer solution may be selected from the group of water soluble polymers of polyvinyl alcohol, polymethylvinyl ether, polyarrylates, polyacrylamides, polysaccarides, gelatins, polylactic acid, and polyglycolic acid. In an embodiment, the polymer solution is aqueous polymethylvinyl ether. The dispersed metal nanoparticles in the monolayer may be between about 2 nm and about 100 nm.

The method requires the preparation of a polymer formulation containing a metal precursor and a subsequent heat treatment. The formulation includes an aqueous solution metal precursor salt, such as gold chloride, in a water soluble, easily pyrolyzed, polymer such as polymethylvinyl ether (PVME). Other metal precursors may be used, such as silver nitrate, platinum chloride, or copper chloride. The resulting film can be cast, for example by spin coating, onto a substrate. The resulting film is baked at a temperature for a prescribed time to induce the formation of metal nanoparticles. In this regard, PVME appears particularly advantageous because of the low temperature and rapid rates with which reduction takes place, without the use of any external reducing agents (chemical or radiation). The resulting film is heated at elevated temperature in air to remove the organic constituents and deposit a well dispersed film of the metal nanoparticles on the substrate.

The size and density of the metal nanoparticle can be controlled by various parameters, including precursor concentration, heating time and temperatures, and film thickness. One skilled in the art will realize that the materials and amounts described herein are a general description and other materials of similar function may be substituted. For example, a variety of polymers are known to support the growth of metal nanoparticles.

### EXAMPLE

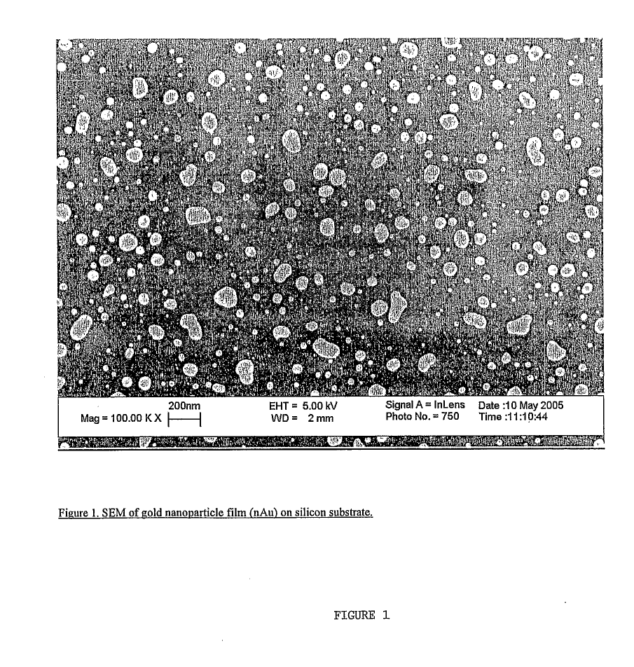

A stock solution of poly(methyl vinyl ether) was prepared by mixing 20.0 g of 50 wt % aqueous PVME solution (Aldrich Chemical) with 20.0 g of water and 6.0 g of isopropanol. A stock solution of 10 wt % aqueous gold (III) chloride trihydrate (Aldrich Chemical) was prepared. The casting solution was prepared by adding 1 part gold chloride stock solution to 10 parts PVME stock solution and stirring to homogeneity. Films were prepared by spin coating onto 1 inch quartz or BK-7 discs at 3000 rpm. The slides were baked at 100° C. for 1 hour. The characteristic red color of gold nanoparticle colloid developed upon drying and heating of the films. The dried film thickness was typically in the 3 microns range. The films were placed into a 450° C. furnace in air to remove the organic constituents, leaving behind a uniform layer of gold nanoparticles. A typical sample prepared on a silicon substrate in shown in FIG. 1, with the particle distribution as determined from approximately 500 particles with the ImageJ program. FIG. 1 is a SEM of a gold nanoparticle film on silicon substrate.

One skilled in the art will realize that while PVME and gold chloride are shown here as the preferred embodiments for the polymer and metal precursor respectively, a variety of water/alcohol soluble polymers and metal salts may be used without restriction as the polymer matrix and gold salt. For polymers, these may include, as non-limiting examples, polyvinylalcohol, polyacrylates, polyacrylamides, polysaccarides, gelatins, polylactic acid, polyglycolic acid, and other water soluble polymers. Metal salts may include any of the salts of gold, silver, platinum, or copper, for example.

The average size and distribution of the particles can be controlled by varying the concentration of the metal precursor, the temperature of the growth phase, and the time of the growth phase. Also, the density of the deposited film can be varied by the film thickness of the cast polymer film. While not necessary, the use of external reducing agents such as ultraviolet light can also be used to vary the rate at which particles are formed.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

What is claimed is:

1. A method of producing a monolayer of dispersed metal nanoparticles substantially free of stabilizing ligands, comprising the steps of:
mixing a polymer solution with a metal salt to create a metal precursor solution;
forming the metal precursor solution into a film by removal of solvent;
heating the film to reduce the metal salt and form metal nanoparticles; and
further heating the film to remove the polymer solution and form a monolayer of dispersed metal nanoparticles.

2. The method of producing a monolayer of dispersed metal nanoparticles of claim 1 wherein said forming the metal precursor solution into a film comprises spin casting the metal precursor solution.

3. The method of producing a monolayer of dispersed metal nanoparticles of claim 1 wherein the metal salt comprises a metal from the group of gold, silver, copper, and platinum.

4. The method of producing a monolayer of dispersed metal nanoparticles of claim 3 wherein the metal salt comprises gold (III) chloride trihydrate.

5. The method of producing a monolayer of dispersed metal nanoparticles of claim 1 wherein the polymer solution is selected from the group of water soluble polymers of polyvinyl alcohol, polymethylvinyl ether, polyarrylates, polyacrylamides, polysaccarides, gelatins, polylactic acid, and polyglycolic acid.

6. The method of producing a monolayer of dispersed metal nanoparticles of claim 5 wherein the polymer solution is aqueous polymethylvinyl ether.

7. The method of producing a monolayer of dispersed metal nanoparticles of claim 1 wherein the dispersed metal nanoparticles in the monolayer are between about 2 nm and about 100 nm.

8. A film of dispersed metal nanoparticles comprising:
a polymer matrix substantially free of stabilizing ligands; and
metal nanoparticles dispersed in said polymer matrix, wherein said nanoparticles are between 2 nm and 100 nm.

9. The film of dispersed metal nanoparticles of claim 8 wherein said metal nanoparticles comprise a metal from the group of gold, silver, copper, and platinum.

10. The film of dispersed metal nanoparticles of claim 9 wherein said metal nanoparticles comprise gold (III) chloride trihydrate reduced to gold nanoparticles.

11. The film of dispersed metal nanoparticles of claim 8 wherein said polymer matrix is selected from a group of water soluble polymers of polyvinyl alcohol, polymethylvinyl ether, polyarrylates, polyacrylamides, polysaccarides, gelatins, polylactic acid, and polyglycolic acid.

12. The film of dispersed metal nanoparticles of claim 11 wherein said polymer matrix is aqueous polymethylvinyl ether.

13. A film of dispersed metal nanoparticles substantially free of stabilizing ligands made from the method comprising the steps of:
mixing a polymer solution with a metal salt to create a metal precursor solution;
forming the metal precursor solution into a film by removal of solvent;
heating the film to reduce the metal salt and form metal nanoparticles; and
further heating the film to remove the polymer solution and form a film of dispersed metal nanoparticles.
